(19) United States
(12) Patent Application Publication
(10) Pub. No.: US 2024/0137895 A1
(43) Pub. Date: Apr. 25, 2024

(54) METHOD FOR GENERATING LOCATION INFORMATION IN A WIRELESS NETWORK

(71) Applicant: Sony Group Corporation, Tokyo (JP)

(72) Inventors: Torgny PALENIUS, Barsebäck (SE); Basuki PRIYANTO, Lund (SE); Nafiseh Seyed MAZLOUM, Lund (SE); Anders BERGGREN, Lund (SE); Rickard LJUNG, Lund (SE); Johan HILL, Lund (SE)

(21) Appl. No.: 18/279,574

(22) PCT Filed: Feb. 23, 2022
(86) PCT No.: PCT/EP2022/054521

§ 371 Date: Aug. 29, 2023

(30) Foreign Application Priority Data
Mar. 14, 2021 (SE) 2150293-5

(51) Int. Cl. H04W 64/00; H04L 41/16

(52) U.S. Cl. CPC H04W 64/00; H04L 41/16

(57) ABSTRACT

A method carried out in a user equipment, UE, (1) for generating location information to a location server (130) in a wireless network (100), the method comprising: receiving (404), from the location server, a location request message identifying a request for location information based on a UE-determined positioning method; obtaining (410) location information using a positioning method selected by the UE out of a plurality of available positioning methods, based on the location request message; transmitting (412) the location information to the location server.

### TECHNICAL FIELD

This disclosure relates to the field of positioning, and specifically to generation of location information usable for determination of a location estimation of a wireless device attached to a wireless network. Specifically, the proposed solutions relate to a determination or evaluation of a positioning method to use for obtaining the location information.

### BACKGROUND

Location or positioning are terms frequently used in the field of wireless communication, for determining a location estimate of an actual position of a mobile device. The determined position or location may be related to a coordinate system, such as defined by e.g. geographical coordinates, or in relation to another position or object.

In 3GPP, (the 3^{rd} Generation Partnership Project) standards for New Radio (NR) and Long Term Evolution (LTE) the LTE Positioning Protocol (LPP) is used for handling positioning signaling between the mobile wireless communication device, herein referred to by the commonly used term user equipment (UE), and various servers in the network. Such servers may include e.g. Location Management Function (LMF), Evolved Serving Mobile Location Centre (E-SMLC) and SUPL (Secure User Plane Location) and Location Platform (SLP). Different positioning methods are used in 3GPP, Satellite-based with network assistance, Assisted-Global Navigation Satellite System (A-GNSS), time difference measurement methods such as Observed time difference of arrival (OTDOA), Uplink Time difference of arrival (UL-TDOA) and downlink time difference of arrival (DL-TDOA), Enhanced Cell-ID (ECID)/(NR-ECID), External Protocol Data Unit (EPDU), Sensors (Motion and Barometric), Terrestrial Beacon Systems (TBS), positioning systems in Local area networks such as wireless LAN (WLAN), Bluetooth, Round Trip Time methods (NR-Multi-RTT) and other angle of direction methods (nr-DL-AoD, NR-DL-AoA).

For UE-Based positioning or UE-assisted positioning, a location server (LS) within the network can request for location information from the UE over a positioning protocol, such as the LPP. The positioning protocol is specified in Technical Specification (TS) 37.355 with stage 2 specifications in TS 36.305 for LTE and TS 38.305 for NR. According to current specifications, the RequestLocationInformation message sent by the network to the UE contains the method(s) to be used. The location information given by the different technologies are independent and separately defined and each has its own accuracy performance given the circumstances. When responding to the Location Information request the location information is provided from the UE in the ProvideLocationInformation message, where the result from each requested method is reported.

The location information requested and reported in the Location Information can be either location estimates (UE-based) or location measurements (UE-assisted). A location estimate refers to an estimated location or position of the UE, whereas a location measurement refers to measurement data which can be used, in the LS, for determining an estimated location or position of the UE. In the protocol, each positioning method and whether it is UE based or UE assisted is requested independently from the server, and the server thus decides which methods the UE shall use. Since the environment changes quite quickly for e.g. GNSS due to shadowing of satellites, small movements of the UE may also change the accuracy of a location method. Therefore, improvements to the current specified signaling and procedures could be envisioned, to achieve better positioning performance for the intended use-case or services in such dynamic situations.

### SUMMARY

A need therefore exists for a method for controlling positioning to determine a location estimate of a UE connected to a wireless network. The proposed solution is defined by the terms of the independent claims.

According to a first aspect, the proposed solution inter alia relates to a method carried out in a UE for generating location information to a location server in a wireless network, the method comprising:
receiving, from the location server, a location request message identifying a request for location information based on a UE-determined positioning method;
obtaining location information using a positioning method selected by the UE out of a plurality of available positioning methods, based on the location request message;
transmitting the location information to the location server.

With respect to said first aspect, the proposed solution further relates to a method carried out in a location server for obtaining location information for a UE connected through a wireless network, the method comprising:
transmitting, to the UE, a location request message identifying a request for location information based on a UE-determined positioning method;
receiving, responsive to the location request message, location information obtained in the UE using a positioning method selected by the UE out of a plurality of available positioning methods, based on the location request message.

According to this first aspect, the proposed solution provides for improved latency and reduced signaling in the obtainment in the location server of location information from the UE, by configuring the UE to select, i.e. determine, the positioning method to use.

According to a second aspect, the proposed solution relates to a method carried out in a location server for validating obtainment of location information from a UE connected through a wireless network, the method comprising:
transmitting, to the UE, a message identifying a request for the UE to determine a positioning method based on a location context;
receiving, responsive to said message, an indication of a positioning method selected by the UE out of a plurality of available positioning methods based on said location context;
transmitting, responsive to the selected positioning method deviating from a preferred positioning method identified in the location server associated with said location context, location assistance data for configuring the UE to select the preferred positioning method based on said location context.

According to this second aspect, the proposed solution provides for validation of the UE being properly configured to determine and select the positioning method known by the location server to be appropriate.

Various non-limiting examples falling within this general scope are laid out in the dependent claims and in the following description.

### BRIEF DESCRIPTION OF THE DRAWINGS

The proposed solutions will now be described in more detail with reference to the accompanying drawings, in which various examples of realizing the solutions are outlined.

FIG. 1 schematically illustrates a wireless network according to some examples, in which the proposed solutions may be set out.

FIG. 2 schematically illustrates a UE configured to operate in accordance with the examples laid out herein.

FIG. 3 schematically illustrates a location server configured to operate in accordance with the examples laid out herein.

FIG. 4 schematically illustrates a signaling diagram of a first aspect of the proposed solution.

FIG. 5 schematically illustrates a signaling diagram of a second aspect of the proposed solution.

### DETAILED DESCRIPTION

In the following description, for purposes of explanation and not limitation, details are set forth herein related to various examples. However, it will be apparent to those skilled in the art that the present disclosure may be practiced in other examples that depart from these specific details. In some instances, detailed descriptions of well-known devices, circuits, and methods are omitted so as not to obscure the description of the present disclosure with unnecessary detail. The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented and are thus machine-implemented. In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) (ASIC), and (where appropriate) state machines capable of performing such functions. In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” shall also be construed to refer to other hardware capable of performing such functions and/or executing software, such as the example hardware recited above.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

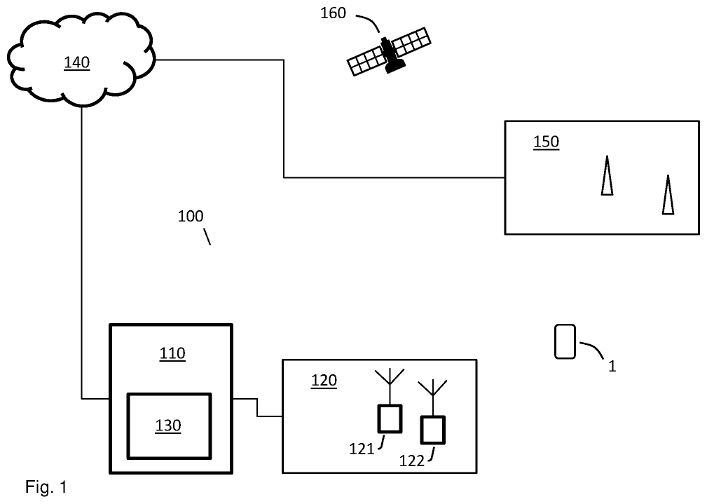

FIG. 1 schematically illustrates a wireless communication scenario, providing an example of a scene in which the solutions provided herein may be incorporated for providing a position estimation of a UE 1.

A wireless network 100 may comprise a core network 110 and one or more access networks 120. The wireless network may be configured according to at least some of the specifications as used by the 3GPP. The core network may e.g. be a 4G EPC or a 5G Core. The core network 110 may further be connected to other communication systems such as the Internet 140. A network node operating as a location server 130 may be connected in the core network 110. In an alternative example, the location server 130 does not form part of the core network 110 but is connected thereto. In another example, a location server 130 can be realized as part of Mobile Edge Computing (MEC) and it can be co-located in one of the access networks in order to reduce the latency. The access network 120 is connected to the core network 110 and is usable for communication with UEs, such as the illustrated UE 1. The access network 120 may comprise a plurality of access nodes or base stations 121, 122, configured to provide a wireless interface for, inter alia, the UE 1. In a 5G network an access node 121, 122 is typically referred to as a gNB, and this term will occasionally be referred to herein as well. The base stations 121, 122 may be stationary or mobile. The actual point of transmission and reception of each base station may be referred to as a Transmission and Reception Point (TRP), which may coincide with an antenna system of the respective base station.

The UE 1 may be any device operable to wirelessly communicate with the network 100 through the base stations 121, 122, such as a mobile telephone, computer, tablet, a machine to machine (M2M) device, an IoT (Internet of Things) device or other.

FIG. 1 further indicates other systems available to the UE 1 for generating location information usable for estimation of the position of the UE 1. In some examples, signals or information transmitted by other wireless transmitters 150 may be detectable in the UE 1, such as Wi-Fi transmitters or Bluetooth transmitters. Moreover, a plurality of satellite transmitters 160 may be provided for GNSS signal transmission.

Before discussing various process solutions for the proposed method, the UE 1 and the positioning server 130 will be functionally discussed on a general level.

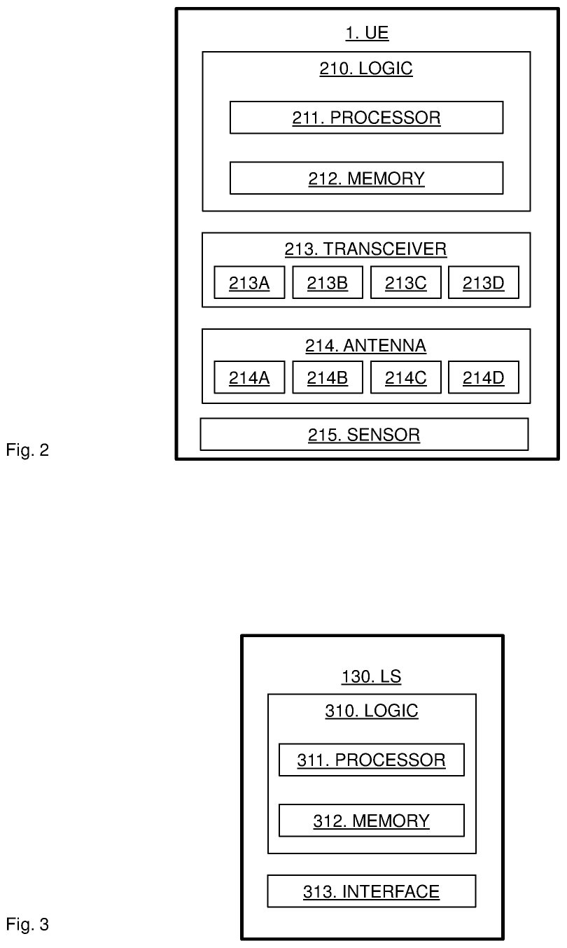

FIG. 2 schematically illustrates an example of the UE 1 for use in a wireless network 100 as presented herein, and for carrying out the method steps as outlined. The UE 1 may be a New Radio (NR) UE in which the UE is connected to a 5G NR cellular system 120.

The UE 1 comprises a radio transceiver 213 for communicating with other entities of the radio communication network 100, such as the base stations 121, 122 and other nodes 150, in various frequency bands. The transceiver 213 may thus include a radio receiver and transmitter for communicating through at least an air interface. As an example, the UE1 may comprise one or more of a transceiver 213A for communication with the access network 120, a transceiver 213B for Wi-Fi communication, a transceiver 213C for Bluetooth communication, and a receiver 213D for obtaining GNSS signals.

The UE 1 further comprises logic 210 configured to communicate data, via the radio transceiver, on a radio channel, to the wireless communication network 100 and possibly directly with another terminal by Device-to Device (D2D) communication.

The logic 210 may include a processing device 211, including one or multiple processors, microprocessors, data processors, co-processors, and/or some other type of component that interprets and/or executes instructions and/or data. The processing device 211 may be implemented as hardware (e.g., a microprocessor, etc.) or a combination of hardware and software (e.g., a system-on-chip (SoC), an application-specific integrated circuit (ASIC), etc.). The processing device 211 may be configured to perform one or multiple operations based on an operating system and/or various applications or programs.

The logic 210 may further include memory storage 212, which may include one or multiple memories and/or one or multiple other types of storage media. For example, the memory storage 212 may include a random access memory (RAM), a dynamic random access memory (DRAM), a cache, a read only memory (ROM), a programmable read only memory (PROM), flash memory, and/or some other type of memory. The memory storage 212 may include a hard disk (e.g., a magnetic disk, an optical disk, a magneto-optic disk, a solid state disk, etc.).

The memory storage 212 is configured for holding computer program code, which may be executed by the processing device 211, wherein the logic 210 is configured to control the UE 1 to carry out any of the method steps as provided herein. Software defined by said computer program code may include an application or a program that provides a function and/or a process. The software may include device firmware, an operating system (OS), or a variety of applications that may execute in the logic 210.

The UE 1 may further comprise an antenna system 214, which may include one or more antenna arrays. In various examples the antenna system 214 comprises different antenna elements configured to communicate with the wireless network 100, and optionally also antenna devices for communication with other nodes 150 and for reception of GNSS signals. As an example, the antenna system 214 may comprise one or more of an antenna 214A for communication with the access network 120, an antenna 214B for Wi-Fi communication, an antenna 214C for Bluetooth communication, and an antenna for receiving GNSS signals.

The UE1 may further comprise one or more sensors 215 usable for positioning of the UE1, such as a gyroscope, a barometer, an accelerometer etc.

Obviously, the UE 1 may include other features and elements than those shown in the drawing or described herein, such as a power supply, a casing, a user interface, further sensors, etc., but are left out for the sake of simplicity.

FIG. 3 schematically illustrates an example of the location server (LS) 130 for use in the wireless network 100 as presented herein, and for carrying out the method steps as outlined.

The LS 130 comprises a communication interface 313 for connection to the other nodes of the core network 110.

The LS 130 further comprises logic 310 configured to communicate measurement data and control signals with the access network 120 and with the UE 1, over one or more different interfaces 313. In various examples, communication with the access network 120 may be carried out using the NRPPa protocol, as outlined in TS 38.455, using an NG core network interface. Communication between the LS 130 and the UE 1 may be carried out using an LTE Positioning Protocol (LPP) as specified in 3GPP TS 37.355. The logic 310 may be partly or completely cloud-based or may be installed in a dedicated node device.

The logic 310 may include a processing device 311, including one or multiple processors, microprocessors, data processors, co-processors, and/or some other type of component that interprets and/or executes instructions and/or data. The processing device 311 may be implemented as hardware (e.g., a microprocessor, etc.) or a combination of hardware and software (e.g., a system-on-chip (SoC), an application-specific integrated circuit (ASIC), etc.). The processing device 311 may be configured to perform one or multiple operations based on an operating system and/or various applications or programs.

The logic 310 may further include memory storage 312, which may include one or multiple memories and/or one or multiple other types of storage mediums. For example, the memory storage 312 may include a random access memory (RAM), a dynamic random access memory (DRAM), a cache, a read only memory (ROM), a programmable read only memory (PROM), flash memory, and/or some other type of memory. The memory storage 312 may include a hard disk (e.g., a magnetic disk, an optical disk, a magneto-optic disk, a solid state disk, etc.).

The memory storage 312 is configured for holding computer program code, which may be executed by the processing device 311, wherein the logic 310 is configured to control the LS 130 to carry out any of the method steps as provided herein. Software defined by said computer program code may include an application or a program that provides a function and/or a process. The software may include device firmware, an operating system (OS), or a variety of applications that may execute in the logic 310.

Various techniques or methods for positioning of mobile devices are available, to obtain location information. One well-known technique involves multi-lateration (e.g. trilateration) and/or multi-angulation (e.g. triangulation) based on received signals, emitted or reflected from a known source. One example is satellite positioning, where positioning signals from satellite transmitters are measured. This may be referred to as Global Navigation Satellite System (GNSS), including a constellation of satellites providing signals from space that transmit positioning and timing data to GNSS receivers. A mobile device comprising a receiver for such signals may thus use this data to determine its position or location. The UE 1 may comprise receivers and logic for generation of location information according to several different techniques, including GNSS. One example is positioning in a cellular wireless network, e.g. operated as outlined in one or more of the technical specifications of 3GPP, (the 3^{rd} Generation Partnership Project). This may involve the UE receiving signals from a plurality of base stations of the wireless network, and measuring various characteristics of the received signals, such as one or more of signal strength, time of arrival (ToA), phase, etc.

An estimate of the position or location of the UE 1 can be calculated based on the location measurement obtained by the UE 1. In some examples a location estimate is determined by the UE 1, based the location measurement. In some examples, the location server 130 controls the signaling and positioning process, and may perform the calculations for determination of the location estimation, based on location measurement obtained from the UE 1. One example of such a technique is UE-assisted OTDOA (Observed Time Difference of Arrival). The UE performs measurement, such as Reference Signal Time Difference (RSTD) measurement and then reports the results to the Location Server to be used for positioning estimation.

Different types of positioning techniques provide location information with different characteristics, such as accuracy, latency, availability etc. GNSS positioning may for instance provide a location estimation accuracy which may be within 10 m, whereas network-based techniques in 4G systems typically provided a lower positioning accuracy of e.g. 50 m or worse. On the other hand, the availability of GNSS signals is normally not particularly good in indoor environments. Other techniques, such as utilizing Bluetooth signals, Wi-Fi signals, inertial measurement sensors, can be used to complement positioning estimation technique in indoor environments.

As noted, a location, such as geo-location coordinates, of the UE 1 can be estimated in the location server 130 or in the UE 1. If needed, the determined location estimation of the UE can then be communicated back to the UE 1, in RRC (Radio Resource Control) connected mode. However, in 3GPP release 16 “UE based positioning” was introduced, where the UE 1 itself can estimate its position, i.e. a location estimate, such as geo-location coordinates. Moreover, further studies have recently been initiated with the objective to address higher accuracy location requirements resulting from new applications and so-called industry verticals.

The proposed solution provides that the UE 1 is configured to evaluate positioning methods, such as to determine a best positioning method among a plurality of available positioning methods usable for obtaining location information. A benefit of the proposed solution is that the UE 1 may be best equipped to evaluate which positioning method is appropriate, based on e.g. its environment.

In the context of the proposed solution, the best positioning method may in some examples be identified as a most suitable positioning method, given a certain criterion or criteria. The criteria may be implicit, or provided in a request for location information, or in a separate message, transmitted by the LS 130. Unless a specific criterion is indicated by the LS 130, one or more default criteria may apply, by specification or as previously conveyed from the LS 130, e.g. in connected mode of the UE 1 or as system information from the wireless network 100. Alternatively, lack of any default criteria or any specific criteria determined by the LS 130, may allow for the UE 1 to determine its criteria for selecting positioning method. The criteria may in various examples comprise any combination of e.g. absolute horizontal accuracy, absolute altitude accuracy, relative accuracy, latency, UE processing, UE energy consumption, integrity-relevance, location area type (e.g. rural, urban, in-door), time of day, UE mobility etc.

In some examples, wherein two or more positioning methods, forming a subset of the available positioning methods supported by the UE 1, are determined to satisfy current criteria, the UE 1 may be configured to select one of said subset of positioning methods. In some examples, the UE 1 is configured with the right to select a positioning method from said subset which is most suitable for the UE 1, e.g. the positioning method which requires the least UE processing and/or UE energy consumption. In some examples, a priority order or a weight value may be assigned to different positioning methods, based on which the UE 1 is configured to determine the selected positioning method from said subset. A level of priority, or weight, may be determined for one or more of the available positioning methods by the LS 130, or by default specification.

In some examples, the criteria may be dependent on, or directly correlated with, a target use case for location determination. Such target use case may e.g. be associated with a specific industry vertical, such as an application related to one of e.g. automotive, energy, manufacturing, healthcare etc. The target use case may in various examples determine the priority or weight value for selection of positioning method from a subset of positioning methods meeting other criteria for selection of positioning method.

The proposed solution thus entails that the LS 130 is able to request the best available positioning method from the UE 1, instead of specifying a requested positioning method according to legacy behavior.

The server should have a certain level of confidence or trust that the UE 1 is capable of performing such operation of evaluating and/or indicating a best available positioning method. In various examples the UE 1 is thus configured to signal this capability to perform the operation of identifying the best available positioning method, e.g. associated with a target use case. The proposal therefore implies that a logic for positioning method selection is implemented in the UE 1. With this method, the dynamics in the environments and therefore the variations in positioning method accuracy can be considered with low latency and limited required signaling. Thereby the performance and latency of the positioning reporting can be improved compared to legacy where the position method is indicated/requested by the location server.

In a first aspect, the proposed solution involves the LS 130 delegating, to the UE 1, a decision of positioning method to use. This may be obtained by a method carried out in the UE 1 for generating location information to the LS 130, wherein the method comprises:
receiving, from the LS 130, a location request message identifying a request for location information based on a UE-determined positioning method;
obtaining location information using a positioning method selected by the UE 1 out of a plurality of available positioning methods, based on the location request message;
transmitting the location information to the LS 130.

According to this first aspect, the proposed solution may further be provided by a method carried out in the LS 130 for obtaining location information for the UE 1 through the wireless network 100, wherein the method comprises:
transmitting, to the UE 1, a location request message identifying a request for location information based on a UE-determined positioning method;
receiving, responsive to the location request message, location information obtained in the UE 1 using a positioning method selected by the UE 1 out of a plurality of available positioning methods, based on the location request message.

The decision of selecting the best available positioning method, taken by the UE 1, may in some examples be enhanced using machine learning (ML), which may be referred to as realization of artificial intelligence (AI). Use and deployment of the ML method may be implementation specific, and the specific implementation of such an ML method is as such not essential. A few aspects of ML are nevertheless described herein, to give a background and rationale to some example implementations. The ML method may be applied to improve the selection of which positioning method to use.

The selection of positioning method from the plurality of available positioning methods may be performed by use of an ML method, which may comprise a machine learning-based model, or ML model for short. An ML model, also known as a machine learning algorithm, is a mathematical algorithm which, when implemented on a computer resource, has the ability to automatically learn and improve from experience without being explicitly programmed. In some examples, the ML model is based on so-called supervised or semi-supervised learning algorithms, which are configured to build a mathematical model on training data. The resulting mathematical model is thus “trained” and is denoted trained ML model. The training data comprises a set of training examples. Each training example has one or more inputs and the desired output. The outputs may be represented by an array or vector, sometimes called a feature vector, and the inputs may be represented by one or more matrices. Through iterative optimization, learning algorithms learn a function that can be used to predict the output associated with new inputs. The ML model may be based on any suitable architecture, including but not limited to convolution neural networks (CNNs).

In the context of the proposed solution, training data may be provided by means of information or data collected or determined by the UE 1, such as signal strength, quality, phase, polarization, or other signal characteristics of signals received from different transmitters, e.g. GNSS satellites, base stations of the wireless network 100, and other transmitters 150. Based on a finalized selection of a positioning method, the ML model may be trained to assist or enhance future selection of positioning method, given a certain context. The context may be a certain physical area, such as a cell, an area type, such as rural, urban, indoor. The context may be a certain radio environment, identified by a certain type, character, quality, strength, or other parameter, of radio signal(s) detected in the UE 1. Specifically, the ML model may be trained by a multitude of UEs attempting to obtain location information within a general area, such as within a cell served by a base station 121, and thereby collecting data for use as training data. By means of the ML model, an improved selection process may be obtained, wherein the UE 1 may be configured to select a positioning method based on a detected current signal or radio environment, without actually having to determine a location measurement or estimate using different positioning methods. This way, a shortened process for selection of positioning method may be obtained.

The UE 1 will, based on the current environment and signals from the respective method, evaluate the available positioning methods and find the best one based on certain criteria. In some cases the UE 1 knows that one of the positioning methods is preferred since it e.g. knows it has better stability in the environment, then that should be used in the selection. The criteria used in the evaluation may be provided by the LS 130 or be independently determined by the UE 1. The UE 1 may, as noted, use an ML model for this evaluation. The UE 1 will use the selected positioning method(s) to either report measurements from or to calculate and report positioning estimates from. For UE-based positioning, after the positioning estimates are ready, the method may provide error/quality estimates. These error/quality estimates may be used in the evaluation of the best method, and as training data for further training of the ML model.

In case of the ML assistance the UE 1 may be provided with the ML model. Obtainment in the UE 1 of the ML model may be carried out at manufacture, or upon loading with operator data when registering to the network 100. Alternatively, the ML model may be transmitted from the network 100 in connection with a location request from the LS 130. The ML model may, as outlined above, be based on learning from many UEs in the actual environment, and potentially other relevant information obtained from various measurements and sources. The advantages of using an already trained ML model is to use data from all other UEs that have been using positioning in the area and with the same scenario or context, and also to add its own measurements and thereby shorten the training period for the device. The ML model can be divided into different (sub)models for different scenarios such as urban, suburban, rural, indoor etc.

In some examples, ML assistance starts with that the UE 1 is provided with an ML model related to the decision of which positioning method to use. The LS 130 may, when it requests location information, also provide the UE with ML assistance data of the methods to consider. The ML assistance data may specify a certain ML model, or data or settings to apply for an ML model at a certain location request. The ML assistance data may be provided in one of a locations request message, or in a separate message, possibly on request from the UE 1 after preferred positioning methods are selected, or in system information, or at Attach, or as a MBMS broadcast message to subscribing UEs, or it can be pre-configured.

As indicated, input to the ML model may be available positioning methods and corresponding performance, e.g. coverage of Wi-Fi, satellites, 3GPP base stations etc., signal strengths, geometries in the systems, number of detected GNSS satellites and the number of detected cellular network base stations, estimated multipath spreads of the systems etc. The criteria to optimize for may also be handled in the ML model.

The UE 1 may use the ML model by entering its measurements, parameters, and criteria to evaluate which positioning method to use. For instance, in the criteria, indicate that altitude is of most interest, a barometer reading may be a better alternative than OTDOA or GNSS.

The response from the UE 1 to the LS 130 can be either that it reports the estimated location or measurements from the best method(s) as in current ProvideLocationInformation message. It may also be signaled in a separate message Best-ProvideLocationInformation, including information of which method(s) are used. Alternatively, there could be an indication, in the current ProvideLocationInformation message, that the method provided has been identified by the UE as the best one.

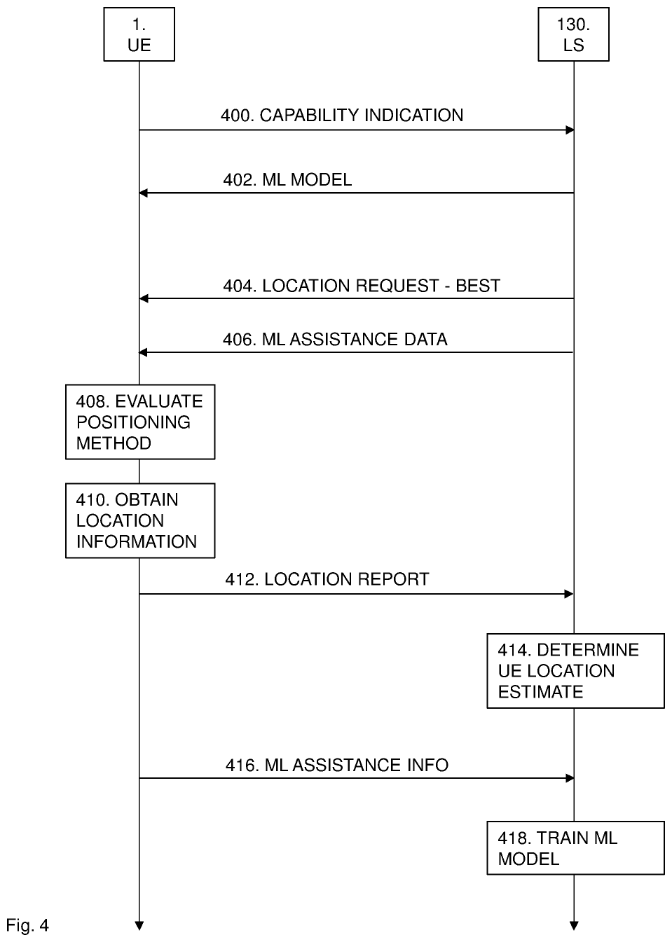

FIG. 4 shows a signaling diagram between the UE 1 and the LS 130, schematically illustrating various examples of the proposed solution. Process steps carried out by the UE 1 are controlled by the logic 210, whereas process steps carried out by the LS 130 are controlled by the logic 310. It shall be noted that not all of the indicated process steps and signals need to be included in every example of the proposed solution. The method serves as a way for the network, or a network node of the network 100 such as the LS 130, to indicate allowance or a request for the UE 1 to make an assessment of the most suitable positioning method, such as the positioning method deemed to be best out of a limited set of positioning methods. This indication could as an example be implemented as an addition of a new request flag/indication as part of the request location information message. A one-bit would be set to on/off for this information.

In step 400, the UE 1 identifies its capabilities and feature sets, which may include an identification of its capability to evaluate and select a best positioning method.

In step 402, an ML model is optionally obtained in the UE 1. As indicated, the obtainment of the ML model, in examples where machine learning is employed, may be carried out prior to registering to the network 100. The ML model is designed for use in evaluation of a best, i.e. most suitable, positioning method in the UE 1, based on various criteria.

In step 404, the LS 130 transmits a location request message, which identifies a request for location information based on a UE-determined positioning method. Criteria to be applied in evaluating and selecting positioning method may in some examples be indicated or conveyed in the location request message 404, or in a separate message.

In step 406, the LS 130 may further transmit ML assistance data to the UE 1. The ML assistance data may be specific to the location request 404 and may be related to a current context or scenario of the UE 1, such as the current location area, or type of area, e.g. associated with the serving cell.

In step 408, the UE 1 makes an evaluation to determine the positioning method to use. The evaluation may be based on the criteria, where applicable, and may result in the selection of one or more positioning methods. This evaluation and selection of positioning methods based on criteria is described for different examples above. Where an ML model is employed, the ML model 402, and potentially additional ML assistance data 406, may be considered in the evaluation 408.

In step 410, location information is obtained in the UE 1 using one or more positioning method selected by the UE 1, out of a plurality of available positioning methods, based on the location request message 404, e.g. based on criteria associated with the location request message 404. The positioning method(s) used is based on the evaluation 408. Where an ML model is employed, this step may further comprise the step of updating the ML model, based on obtained information when evaluating 408 positioning method.

In step 412, the UE 1 transmits a location report, comprising the obtained location information to the LS 130. In some examples, information on the used positioning method is also included in the location report 412, or transmitted in a separate message.

In step 414, the LS 130 may be configured to determine a location estimate of the UE, based on the location report 412 providing only a location estimate. The location estimate may further be transmitted to the UE 1 (not shown).

In step 416, where an ML model is employed, the method may further comprise transmitting ML assistance information to the LS 130. The ML assistance information 414 may provide information on data associated with a present context of the UE 1, such as a radio environment, based on which the decision to use the selected positioning method(s) was taken.

In step 418, the LS 130 may use data of the location report 412 and the ML assistance information 416 to update the ML model. Alternatively, the UE 1 locally trains the ML model and signals the updated model/part of model to the LS 130. The existing ML model may thereby be updated for future use by any UE present in the context of the UE 1.

According to a second aspect of the proposed solution, the LS 130 is arranged to configure the UE 1 to make an appropriate selection of positioning method. This second aspect of the proposed solution may be combined with the method of the first aspect, as provided in FIG. 4, or stand alone.

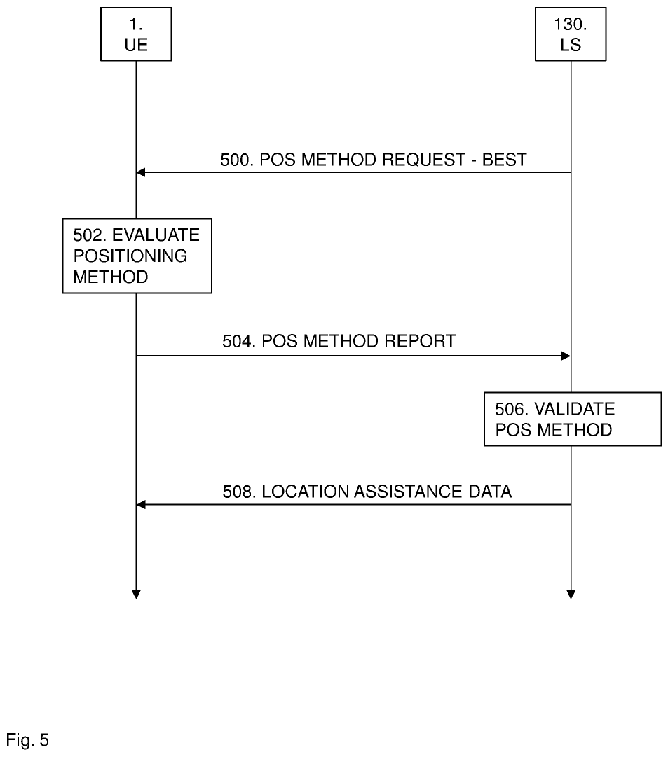

FIG. 5 shows a signaling diagram between the UE 1 and the LS 130, schematically illustrating various examples of the proposed solution, according to the second aspect. The method serves as a way for the network, such as the LS 130, to validate that the UE 1 is configured to make a proper assessment and selection of a positioning method, based on a location request message from the LS 130 (in accordance with FIG. 4). FIG. 5 thus provides a method carried out in the LS 130 for validating obtainment of location information from the UE 1, to which the LS 130 is connected through the wireless network 100. Process steps carried out by the UE 1 are controlled by the logic 210, whereas process steps carried out by the LS 130 are controlled by the logic 310.

In step 500, the LS 130 transmits a message to the UE, identifying a request for the UE to determine a positioning method based on a location context. The location context may be any of the previously outlined examples. Moreover, the location context may comprise or identify one or more criteria, for use by the UE 1 to select a positioning method, as described.

In step 502, the UE 1 evaluates available positioning methods, based on the location context, and determines a selected positioning method.

In step 504, the UE 1 transmits a message comprising an indication of the selected positioning method. Optionally, the UE 1 further transmits location information obtained by the selected positioning method, similar to the process of FIG. 4.

In step 506, the LS 130 validates the selected positioning method. This validation may comprise comparing or correlating the selected positioning method with a preferred positioning method, identified in the LS 130 associated with said location context. In plain words, the LS 130 is thereby configured to validate that the UE 1 is configured to make an appropriate choice of positioning method, given the present location context.

In step 508, the LS 130 transmits, responsive to the selected positioning method deviating from the preferred positioning method, location assistance data for configuring the UE to select the preferred positioning method based on said location context. In case the UE selected positioning method is the same as the LS preferred positioning method (i.e., no deviation), location assistance data for configuring the UE can contain the confirmation indication.

By means of these steps, the LS 130 configures the UE, such that it may operate properly and as expected, e.g. in the process described with reference to FIG. 4.

The location assistance data may comprise priority values, weight values, or other data configured to adapt the evaluation process of step 502 going forward.

In some examples, the evaluation of step 502 employs an ML model, as outlined at various instances in the present disclosure. The ML model is designed for use in evaluation of a best, i.e. most suitable, positioning method in the UE 1, based on the location context, e.g. reflecting various criteria. The LS 130 operates the same, or a corresponding ML model, which may be based on selection of positioning model carried out by a multitude of UEs in the present location context, as outlined. Based on the present location context and the central ML model operated therein, the LS 130 knows that one positioning method is the best one of the available positioning methods, i.e. the one the UE 1 is expected to select. The LS 130 may however occasionally need to validate whether or not the local ML model in the UE 1 is valid. This may e.g. be the case responsive to the UE 1 registering to the wireless network 100 for the first time, or after being disconnected or not having provided location information for a period of time exceeding a threshold level. By means of the proposed steps of FIG. 5, validation of proper configuration in the UE 1 for positioning method selection is ensured.

As seen from the perspective of the UE, the method outlined with reference to FIG. 5 relates to a method carried out in a user equipment, UE, (1) for validating obtainment of location information for delivery to a location server (130) connected through a wireless network (100), the method comprising:
receiving (500), from the location server, a message identifying a request for the UE to determine a positioning method based on a location context;
evaluating (502) available positioning methods to determine a selected positioning method based on said location context receiving (504);
transmitting (504), to the location server, an indication of the selected positioning method;
receiving (508), responsive to the selected positioning method deviating from a preferred positioning method identified in the location server associated with said location context, location assistance data from the location server for configuring the UE to select the preferred positioning method based on said location context.

The proposed solution may be provided by any combination of the subject matter as set out in the foregoing.

1. A method carried out in a user equipment (UE) for generating location information to a location server in a wireless network, the method comprising:
receiving, from the location server, a location request message identifying a request for location information based on a UE-determined positioning method;
obtaining location information using a positioning method selected by the UE out of a plurality of available positioning methods, based on the location request message;
transmitting the location information to the location server.

2. The method of claim 1, comprising: wherein the used positioning method is selected based on information associated with the location request message.

3. The method of claim 2, wherein said information identifies at least one location criterion or location context.

4. The method of claim 2, wherein said information identifies at least one location determination use case.

5. The method of claim 1, comprising: transmitting an indication of the used positioning method to the location server.

6. The method of claim 1, comprising: transmitting capability information to the wireless network, indicating a capability of the UE to optimize location information obtainment by selective use of a positioning method dependent on information associated with a location request message.

7. The method of claim 1, comprising,
obtaining a machine learning model associated with the location request message;
determining the selected positioning method based on at least said machine learning model.

8. The method of claim 7, wherein said machine learning model is based on location information obtained for a multitude of UEs having a context in common with said UE.

9. The method of claim 8, wherein said context comprises a physical area.

10. The method of claim 8, wherein said context comprises a location determination use case.

11. The method of claim 7, comprising: transmitting update information associated with the machine learning model to the location server.

12. The method of claim 1, wherein said location information is a location estimate of the UE, determined by the UE.

13. The method of claim 1, wherein said location information is location measurement obtained by the UE, for assisting the location server to determine a location estimate of the UE.

14. A method carried out in a location server for obtaining location information for a user equipment (UE) connected through a wireless network, the method comprising:
transmitting, to the UE, a location request message identifying a request for location information based on a UE-determined positioning method;
receiving, responsive to the location request message, location information obtained in the UE using a positioning method selected by the UE out of a plurality of available positioning methods, based on the location request message.

15. The method of claim 14, wherein the location request message identifies information usable by the UE for selecting positioning method.

16. The method of claim 15, wherein said information identifies at least one location criterion or location context.

17. The method of claim 15, wherein said information identifies at least one location determination use case.

18. The method of claim 14, comprising: receiving, from the UE, an indication of the used positioning method.

19. The method of claim 14, comprising:
obtaining, through the wireless network, capability information indicating a capability of the UE to optimize location information obtainment by selective use of a positioning method dependent on information provided in association with a location request message;
wherein location request message is configured to identify a request for location information based on said capability information.

20-26. (canceled)

27. A method carried out in a location server for validating obtainment of location information from a user equipment (UE) connected through a wireless network, the method comprising:
transmitting, to the UE, a message identifying a request for the UE to determine a positioning method based on a location context;
receiving, responsive to said message, an indication of a positioning method selected by the UE out of a plurality of available positioning methods based on said location context;
transmitting, responsive to the selected positioning method deviating from a preferred positioning method identified in the location server associated with said location context, location assistance data for configuring the UE to select the preferred positioning method based on said location context.

28. (canceled)
